(19) United States
(12) Patent Application Publication
(10) Pub. No.: US 2025/0077641 A1
(43) Pub. Date: Mar. 6, 2025

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Yutaro MIZUSAKI, Kanagawa (JP)

(73) Assignee: FUJIFILM Business Innovation Corp., Tokyo (JP)

(21) Appl. No.: 18/423,267

(22) Filed: Jan. 25, 2024

(30) Foreign Application Priority Data
Aug. 31, 2023 (JP) 2023-141426

(51) Int. Cl. G06F 21/44; G06F 21/32

(52) U.S. Cl. CPC G06F 21/445; G06F 21/32

(57) ABSTRACT

An information processing system includes a processor configured to: issue provisional authentication information in response to a request from a first user who is an administrator managing an authentication target apparatus, the provisional authentication information being assigned a validity period; when a second user who is to perform maintenance operation for the authentication target apparatus logs in using first authentication information that is memory information or possession information assigned in advance to the second user, request the second user to enter provisional authentication information if second authentication information is not registered, the second authentication information being biological information associated with the second user who has logged in; and register the biological information of the second user as the second authentication information if the provisional authentication information entered by the second user matches the provisional authentication information issued in advance.

### CROSS-REFERENCE TO RELATED APPLICATIONS

This application is based on and claims priority under 35 USC 119 from Japanese Patent Application No. 2023-141426 filed Aug. 31, 2023.

### BACKGROUND

### (i) Technical Field

The present disclosure relates to an information processing system, an information processing method, and a non-transitory computer readable medium.

### (ii) Related Art

Japanese Unexamined Patent Application Publication No. 2002-222168 discloses a personal authentication system that enables a person acting as proxy to perform a task regarding a target process allowed to be performed when the result of personal authentication is valid.

### SUMMARY

Demands for enhanced security during the use of an apparatus or a system have been increasing in recent years. Thus, a user who is to use an apparatus or a system is sometimes requested to undergo multi-factor authentication in which the user is identified by using authentication information based on multiple elements selected from three elements consisting of memory information, possession information, and biological information.

For various apparatuses or systems, memory information or possession information is sometimes assigned to maintenance operators in advance, and such information is used by a user who performs maintenance operation for an apparatus or a system. However, if a user who only knows memory information for maintenance operation or only has possession information for maintenance operation is allowed to use the apparatus or the system, an authentication process involving multi-factor authentication is not performed.

Aspects of non-limiting embodiments of the present disclosure relate to providing an information processing system, an information processing method, and a non-transitory computer readable medium capable of causing a user, who is unregistered in advance and expected to perform maintenance operation, to undergo an authentication process involving multi-factor authentication based on memory information and biological information.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: issue provisional authentication information in response to a request from a first user who is an administrator managing an authentication target apparatus, the provisional authentication information being assigned a validity period;

when a second user who is to perform maintenance operation for the authentication target apparatus logs in using first authentication information that is memory information or possession information assigned in advance to the second user, request the second user to enter provisional authentication information if second authentication information is not registered, the second authentication information being biological information associated with the second user who has logged in; and register the biological information of the second user as the second authentication information if the provisional authentication information entered by the second user matches the provisional authentication information issued in advance.

### BRIEF DESCRIPTION OF THE DRAWINGS

An exemplary embodiment of the present disclosure will be described in detail based on the following figures, wherein:

FIG. 1 depicts a system configuration of an information processing system according to the exemplary embodiment of the present disclosure;

FIG. 2 is a block diagram depicting a hardware configuration of an image forming apparatus according to the exemplary embodiment of the present disclosure;

FIG. 3 is a block diagram depicting a functional configuration of the image forming apparatus according to the exemplary embodiment of the present disclosure;

FIG. 4 depicts an example of authentication information including IDs and passwords that is managed in the image forming apparatus;

FIG. 5 is a flowchart depicting a situation in which a user undergoes multi-factor authentication when using the image forming apparatus;

FIG. 6 is a sequence chart depicting data transmission and reception performed between the image forming apparatus and a proxy authentication server while multi-factor authentication is performed;

FIG. 7 is an illustration for describing a situation in which a machine administrator issues a one-time password (OTP) for maintenance and informs a customer engineer (CE), who is to make a visit, of the OTP for maintenance that has been issued in the image forming apparatus;

FIG. 8 is a flowchart for describing a process performed when the CE visits a client company and logs in to the image forming apparatus using the OTP for maintenance that has been issued;

FIG. 9 is a flowchart for describing in detail a step described in the flowchart in FIG. 8 for a process for new registration of fingerprint information of the CE;

FIG. 10 is a sequence chart depicting data transmission and reception performed between the image forming apparatus and the proxy authentication server when a process is performed to register the fingerprint information of the CE;

FIG. 11 depicts an example of an operation screen displayed by an operation panel of the image forming apparatus when an ID for the CE and a password for the CE are entered;

FIG. 12 depicts an example of an operation screen displayed by the operation panel of the image forming apparatus when the fingerprint information of the CE is acquired; and

FIG. 13 depicts an example of an operation screen requesting the CE to enter the OTP for maintenance and information regarding the machine administrator having issued the OTP for maintenance.

### DETAILED DESCRIPTION

Next, an exemplary embodiment of the present disclosure will be described in detail with reference to the drawings.

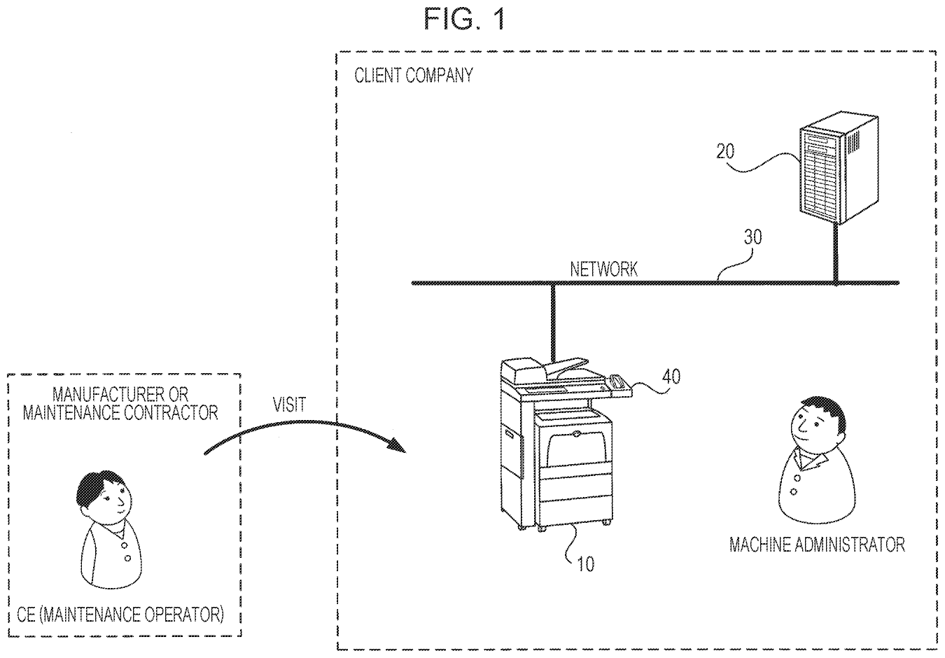

FIG. 1 depicts a system configuration of an information processing system according to the exemplary embodiment of the present disclosure.

As depicted in FIG. 1, the information processing system according to the exemplary embodiment of the present disclosure includes an image forming apparatus 10 and a proxy authentication server 20 connected with each other using a network 30 in a client company. The image forming apparatus 10 has multiple functions such as a print function, a scan function, a copying function, and a facsimile function and is a so-called multifunction peripheral. The proxy authentication server 20 is an authenticating apparatus having a function of authenticating a user who is to use the image forming apparatus 10.

The image forming apparatus 10 is equipped with a fingerprint reader 40. The fingerprint reader 40 is configured to read a fingerprint of a user's finger and acquire data as fingerprint information.

Demands for enhanced security during the use of an apparatus or a system have been increasing in recent years. Thus, the information processing system according to the present exemplary embodiment is configured to identify a user who is to use the image forming apparatus 10 by performing multi-factor authentication.

In the multi-factor authentication, a user is identified by using authentication information including multiple elements selected from three elements consisting of memory information (alternatively referred to as knowledge information) such as a password, possession information that is information regarding a device such as an IC card or a cellular phone possessed by a person who is to be authenticated, and biological information such as a fingerprint, a retina pattern, and a vein pattern.

Specifically, when a user logs in to the image forming apparatus 10, fingerprint information of the user is read by the fingerprint reader 40, and the user is authenticated by the proxy authentication server 20 as well as being authenticated using an ID and a password. In other words, the identity of the user who is to use the image forming apparatus 10 is verified through both types of authentication which are authentication based on memory information using the password performed by the image forming apparatus 10 and authentication based on fingerprint information performed by the proxy authentication server 20.

There are two kinds of users in the client company, that is, a general user who only uses the image forming apparatus 10 and a machine administrator who manages the image forming apparatus 10. A machine administrator is accorded a wider privilege than a general user and may perform various operations that a general user is not accorded a privilege to perform, such as changing the configuration.

However, since a machine administrator is selected to perform only management of the image forming apparatus 10 in the client company, advanced operation involving, for example, more complicated technical configurations, investigation into a cause of an anomaly that has occurred, and a change of parts is delegated to a maintenance operator referred to as a customer engineer (abbreviated to a CE below) having expert knowledge.

A maintenance operator not only refers to a person who performs management and maintenance for the apparatus or the system but also refers to a person expected to perform operations such as repair, maintenance, installation, and inspection of the apparatus or the system.

The CE is usually sent from a manufacturer or a maintenance contractor commissioned by the client company to perform maintenance operation, and the CE visits the client company to perform maintenance operation for the image forming apparatus 10.

To allow the CE to perform such operation, the image forming apparatus 10 is assigned in advance an ID for CE, which is an ID for the CE who performs maintenance operation, and a PW for CE, which is a password for the CE. The CE, who has visited the client company, may log in to the image forming apparatus 10 as the CE using the ID for CE and the PW for CE. However, security concerns arise if a person who only knows the ID for CE and the PW for CE is allowed to use the image forming apparatus 10. Accordingly, the image forming apparatus 10 is designed to transition to the CE mode to allow the CE to perform various kinds of maintenance operation when the CE logs in, and the transition to the CE mode occurs in response to a password for maintenance, which is assigned to the image forming apparatus 10 in advance, being entered by the machine administrator.

However, since what kind of person is sent from the manufacturer or the maintenance contractor is not known in advance and the fingerprint information of the CE is not registered in the proxy authentication server 20, the image forming apparatus 10 configured to perform multi-factor authentication involving authentication based on memory information and authentication based on fingerprint information is not able to implement multi-factor authentication for the CE. Further, if the machine administrator is always requested to enter the password for maintenance whenever the CE logs in in the CE mode, the machine administrator needs to always stay near the CE, which sometimes leads to inconvenience.

Thus, the information processing system according to the present exemplary embodiment is configured to perform such control as described below and is thereby also capable of causing the CE, who is a user unregistered in advance and expected to perform maintenance operation, to undergo an authentication process involving multi-factor authentication based on memory information and biological information.

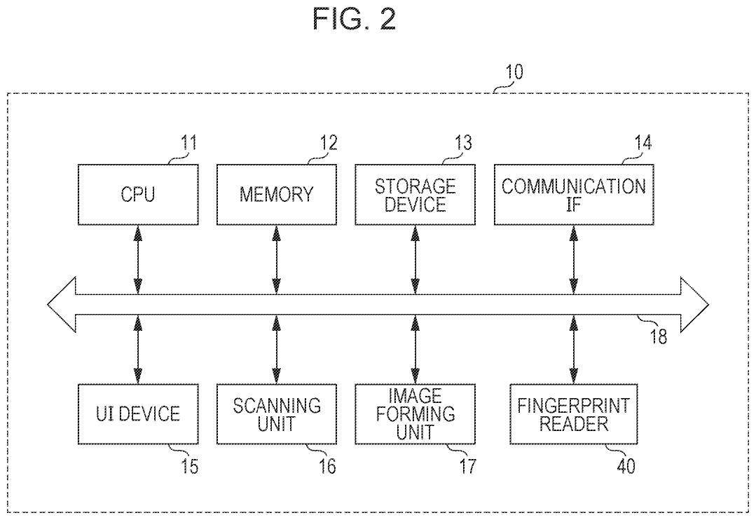

Next, FIG. 2 depicts a hardware configuration of the image forming apparatus 10 in the information processing system according to the present exemplary embodiment.

As depicted in FIG. 2, the image forming apparatus 10 includes a central processing unit (CPU) 11, a memory 12, a storage device 13 such as a hard disk drive, a communication interface (abbreviated to IF) 14 configured to transmit and receive data to and from an external apparatus and the like via the network 30, a user-interface (abbreviated to UI) device 15 including a touch panel or a combination of a liquid crystal display and a keyboard, a scanning unit 16, an image forming unit 17, and the fingerprint reader 40. These components are connected to each other by using a control bus 18.

The image forming unit 17 is configured to print an image on a recording medium such as a sheet of printing paper after performing processes such as charging, exposure, development, transfer, and fixing.

The CPU 11 is a processor that is configured to perform predetermined processing in accordance with a control program stored in the memory 12 or in the storage device 13 and that is configured to control operation of the image forming apparatus 10. Although the description in the present exemplary embodiment will be given on the assumption that the CPU 11 is configured to read and execute the control program stored in the memory 12 or in the storage device 13, the description will be given by way of illustration and not by way of limitation. The control program may be recorded in a computer-readable recording medium and provided in the form of the computer-readable recording medium. For example, the program may be stored in an optical disc, such as a compact disc read-only memory (CD-ROM) and a digital versatile disc read-only memory (DVD-ROM), or a semiconductor memory, such as a universal serial bus (USB) memory and a memory card, and such a recording medium may be provided. Further, the control program may be acquired from an external apparatus via a communication line connected to the communication interface 14.

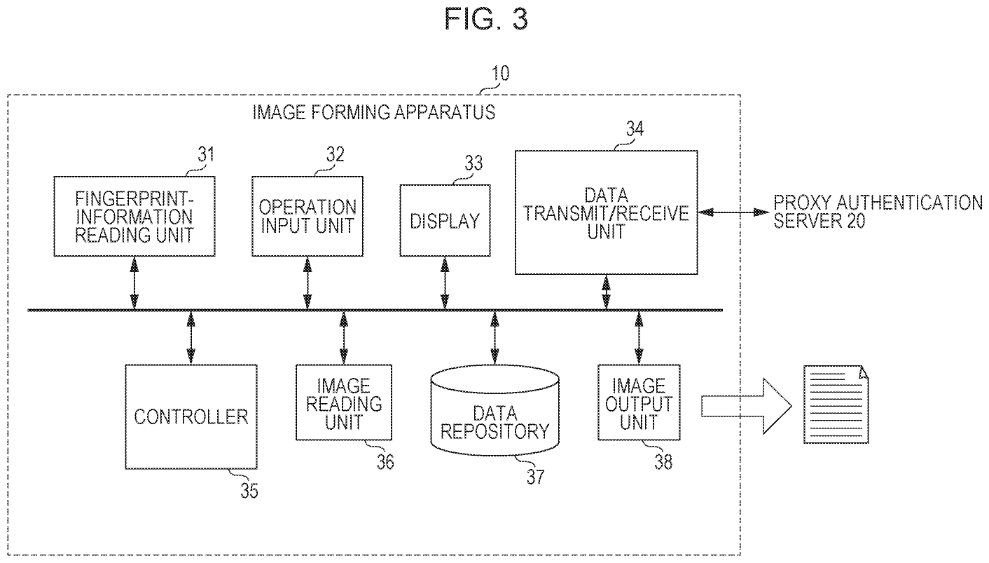

FIG. 3 is a block diagram depicting a functional configuration of the image forming apparatus 10 implemented by the execution of the control program described above.

As depicted in FIG. 3, the image forming apparatus 10 according to the present exemplary embodiment includes a fingerprint-information reading unit 31, an operation input unit 32, a display 33, a data transmit/receive unit 34, a controller 35, an image reading unit 36, a data repository 37, and an image output unit 38.

The fingerprint-information reading unit 31 is configured to read fingerprint information from a user's finger placed on the fingerprint reader 40.

The display 33 is controlled by the controller 35 and is configured to display various kinds of information to a user. The operation input unit 32 is configured to receive information regarding various operations performed by the user. The data transmit/receive unit 34 is configured to transmit and receive data to and from an external apparatus such as the proxy authentication server 20.

The image output unit 38 is configured to output an image on a recording medium such as a sheet of printing paper in accordance with the control by the controller 35. The image reading unit 36 is configured to read a document image from a placed document in accordance with control by the controller 35.

The controller 35 is configured to control the image output unit 38 to perform a printing process and control the image reading unit 36 to perform a process of reading a document image. The data repository 37 is configured to store various kinds of data including printing data created by the controller 35. The data repository 37 stores, for each user, an ID and a password that are paired in advance.

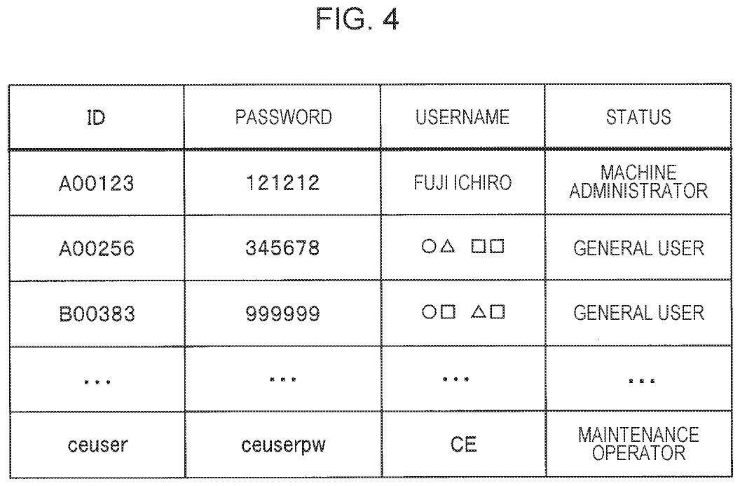

FIG. 4 depicts an example of authentication information including IDs and passwords that is managed in this way in the image forming apparatus 10. As may be seen by referring to FIG. 4, for each user, information including an ID and a password as identifying information, a username, and a privilege is managed. Description will be given herein on the assumption that a string “ceuser” is assigned to the CE as the ID, and a string “ceuserpw” is assigned to the CE as the password.

In addition, each user is accorded a privilege to use the image forming apparatus 10 and is granted general user status, machine administrator status, or CE (maintenance operator) status. When a user logs in to the image forming apparatus 10 using an ID and a password in this way, the user is identified and is able to perform operation within a range according to the status granted to the identified user.

Next, operation of the image forming apparatus 10 in the information processing system according to the present exemplary embodiment will be described in detail with reference to the drawings.

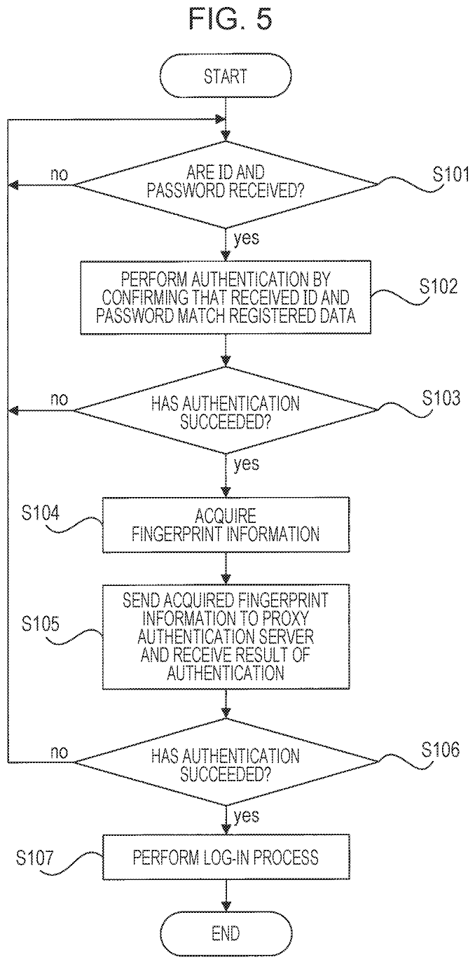

The flowchart in FIG. 5 depicts a situation in which a user undergoes multi-factor authentication when using the image forming apparatus 10.

In response to the operation input unit 32 receiving input of an ID and a password from the user in step S101, the controller 35 authenticates the user in step S102 by confirming that the ID and the password that have been received match those registered in advance.

Then, in step S103, the controller 35 determines that the authentication has succeeded if the ID and the password that have been received match those registered in advance and determines that the authentication has failed if the ID and the password that have been received do not match those registered in advance.

If it is determined in step S103 that the authentication has succeeded, the controller 35 causes the fingerprint-information reading unit 31 to acquire fingerprint information of the user in step S104.

Then, in step S105, the controller 35 sends the acquired fingerprint information to the proxy authentication server 20 and receives the result of authentication sent from the proxy authentication server 20.

Subsequently, based on the result of authentication received from the proxy authentication server 20, the controller 35 determines in step S106 whether authentication based on the fingerprint information has succeeded.

If it is determined in step S106 that the authentication has succeeded, the controller 35 allows the user to log in and performs a log-in process in step S107.

If it is determined that the authentication has failed in step S103 or S106, the controller 35 returns to the process in step S101.

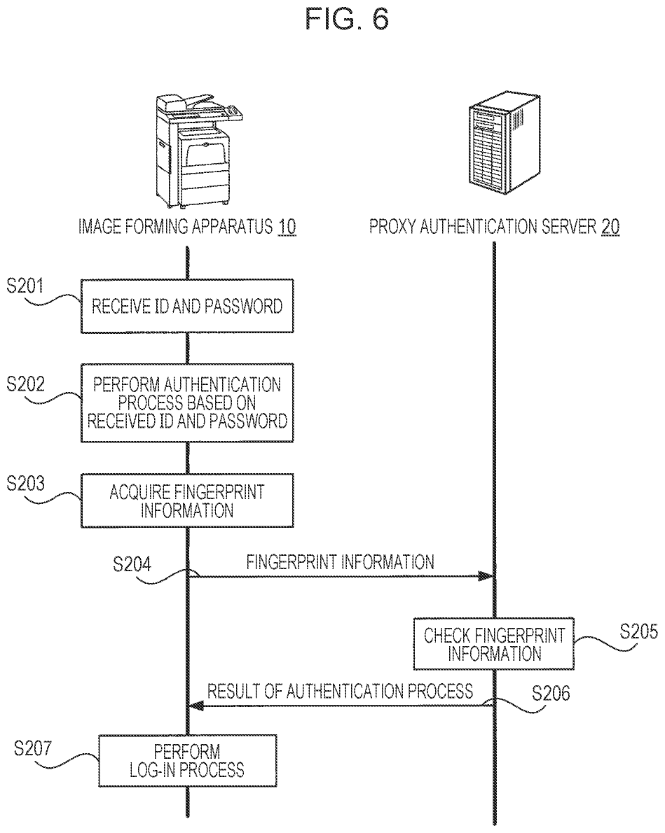

The sequence chart in FIG. 6 depicts data transmission and reception performed between the image forming apparatus 10 and the proxy authentication server 20 while the multi-factor authentication described above is performed.

First, the image forming apparatus 10 receives an ID and a password from the user via an operation panel in step S201.

Then, the image forming apparatus 10 performs an authentication process in step S202 by determining whether the ID and the password that have been received match those registered in advance.

Next, the image forming apparatus 10 acquires fingerprint information of the user with the fingerprint reader 40 in step S203. In step S204, the acquired fingerprint information is sent to the proxy authentication server 20 together with information including the ID information of the identified user.

Then, the proxy authentication server 20 performs an authentication process in step S205 by checking whether the fingerprint information received from the image forming apparatus 10 match the fingerprint information of the user registered in advance. The result of the authentication process is sent to the image forming apparatus 10 in step S206.

Finally, the image forming apparatus 10 confirms in step S207 that the result of the authentication process that has been sent from the proxy authentication server 20 indicates successful authentication and performs a log-in process.

The processes such as depicted in FIG. 5 and FIG. 6 described above are performed to implement multi-factor authentication involving authentication based on memory information and authentication based on biological information. In this multi-factor authentication, the memory information is the information regarding the ID and the password entered by the user who is to use the image forming apparatus 10, and the biological information is the fingerprint information of the user.

To perform the authentication based on the fingerprint information, the fingerprint information of the user who is to be authenticated needs to be stored in the proxy authentication server 20 in advance. However, the fingerprint information of the CE, who is a maintenance operator sent from the manufacturer or the maintenance contractor, is not registered in the proxy authentication server 20 in advance.

Thus, the image forming apparatus 10 according to the present exemplary embodiment is configured to perform a process as follows to implement the multi-factor authentication for the CE.

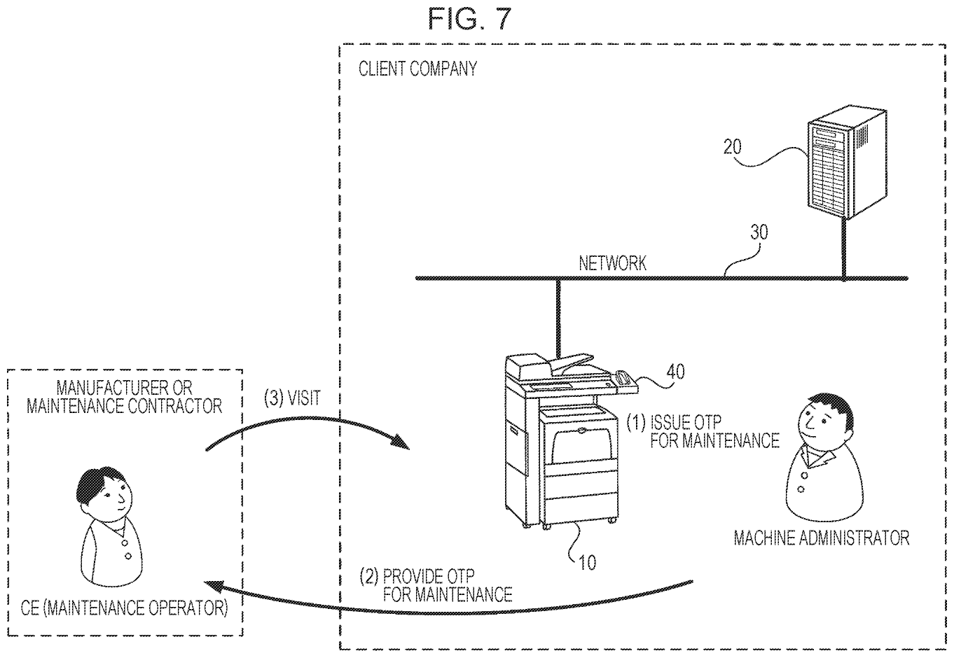

(1) As depicted in FIG. 7, the machine administrator first operates the image forming apparatus 10 to acquire a one-time password for maintenance (hereinafter, abbreviated to the OTP for maintenance). Specifically, the controller 35 issues the OTP for maintenance in response to a request from the machine administrator who is the manager managing the image forming apparatus 10 as the authentication target apparatus. The OTP for maintenance is provisional authentication information assigned a validity period in advance and becomes invalid after the validity period expires. For example, if the validity period of the OTP for maintenance is set to 2 days, the OTP for maintenance becomes invalid on the third day after the issuance. In the following description, description will be given on the assumption that the OTP for maintenance is a string “348567”. The image forming apparatus 10 saves the information regarding the OTP for maintenance that has been issued, together with the information regarding, for example, the ID number of the machine administrator who has instructed the issuance.

(2) Next, the machine administrator informs the CE who is to make a visit of the OTP for maintenance that has been issued. For example, the machine administrator informs the CE of the OTP for maintenance via email, telephone, or other methods on the day before the CE's planned visit.

(3) Then, the CE visits the client company to perform maintenance operation for the image forming apparatus 10 on the day of the planned visit.

The machine administrator may inform the CE of the OTP for maintenance before the visit, or the machine administrator may inform the CE, who has made a visit, in person on the day of the visit.

An authentication process is performed in the image forming apparatus 10 as follows to authenticate the CE, who has visited the client company where the image forming apparatus 10 is installed.

In the present exemplary embodiment, an ID for the CE and a password for the CE as authentication information based on memory information are assigned in advance to the CE who is to perform maintenance operation for the image forming apparatus 10. When the CE logs in using the ID for the CE and the password for the CE, the controller 35 requests the CE to enter the OTP for maintenance if fingerprint information that is biological information associated with the CE who has logged in is not registered in the proxy authentication server 20. If the OTP for maintenance entered by the CE matches the OTP for maintenance issued in advance, the controller 35 registers the fingerprint information of the CE in the proxy authentication server 20.

When the CE logs in using the ID for the CE and the password for the CE and fingerprint information of the CE who has logged in is registered, the controller 35 causes the CE to undergo an authentication process based on the fingerprint information, and the controller 35 allows the CE to use the image forming apparatus 10 if the authentication succeeds.

In the present exemplary embodiment, although description will be given in the case where information regarding the ID for the CE and the password for the CE is assigned to the CE as authentication information in advance, an IC card for the CE, a USB memory storing an authentication code, or other devices may be assigned as possession information in advance.

The controller 35 is configured to, when allowing the CE to use the image forming apparatus 10, accord the CE a privilege to perform a process or processes that the machine administrator is not accorded a privilege to perform. In other words, the controller 35 may be configured to allow the CE to perform operation that the machine administrator is not accorded a privilege to perform.

Further, the controller 35 is configured to associate the OTP for maintenance that has been issued with information including the ID number and the name of the machine administrator who has requested the issuance of the OTP for maintenance, and the controller 35 is configured to cause the data repository 37 to store the OTP for maintenance and the above information regarding the machine administrator in association with each other. The controller 35 is configured to, when receiving the OTP for maintenance from the CE, prompt the CE to enter information regarding the machine administrator having issued the OTP for maintenance, and the controller 35 is configured to register the fingerprint information of the CE as the authentication information of the CE only if the information regarding the machine administrator that has been entered matches the information regarding the machine administrator that is stored in the data repository 37.

Further, the controller 35 may be configured to, when receiving the OTP for maintenance from the CE, cause the display 33 to display information such as the names of multiple users including the machine administrator and prompt the CE to enter the information regarding the machine administrator having issued the OTP for maintenance by selecting one user from the multiple users that are displayed.

The controller 35 may be configured to, when registering the fingerprint information of the CE as the authentication information in the proxy authentication server 20, assign a validity period to the fingerprint information to be registered, and invalidate the fingerprint information when the validity period expires. The validity period is assigned in this way to the fingerprint information of the CE to be registered because, without the validity period assigned to the fingerprint information of the CE that has been registered, the fingerprint information will be valid permanently, and the CE, who might maliciously try to use the image forming apparatus 10 at a later date, may be allowed use the image forming apparatus 10.

In the present exemplary embodiment, description is given with regard to the case where the fingerprint information is used as the biological information involved in the multi-factor authentication, but information such as a vein pattern or a retina pattern may be used as the biological information. Description is given with regard to the case where the memory information is authentication information consisting of the information regarding the ID and the password, but the above procedure may also be performed in a similar manner in a case where a single authentication code is used as the memory information.

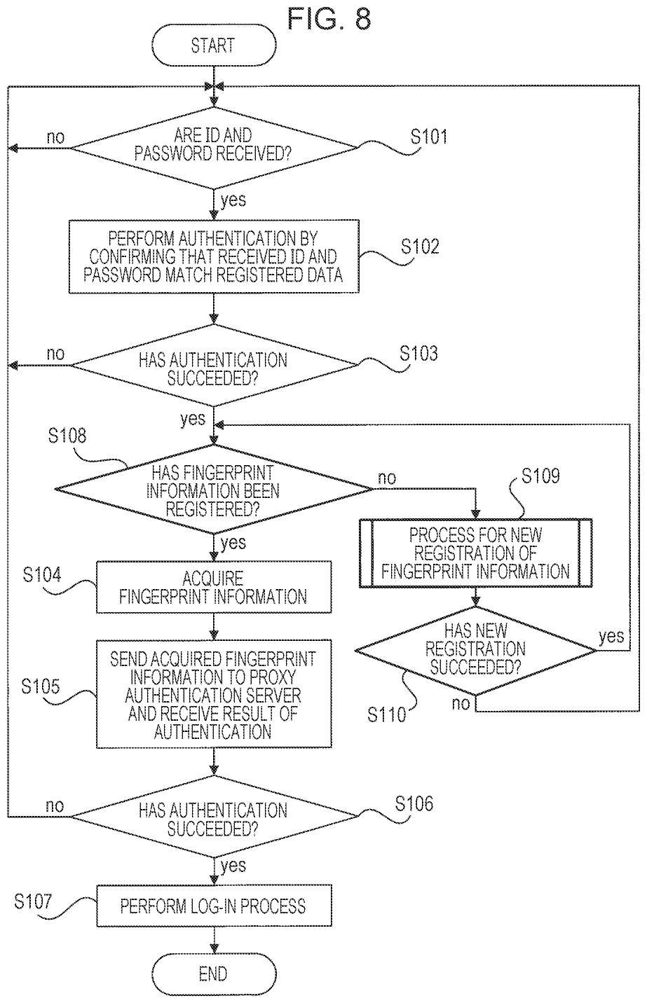

Referring to the flowchart in FIG. 8, description will be given with regard to a process performed when the CE visits the client company and logs in to the image forming apparatus 10 using the OTP for maintenance that has been issued.

Since the flowchart in FIG. 8 is obtained by adding processes in steps S108 to S110 to the flowchart depicted in FIG. 5, the processes in steps S108 to S110, which are added, will only be described in detail in the following description.

If it is determined in step S103 that the authentication has succeeded, the controller 35 determines in step S108 whether the fingerprint information of the CE has been registered in the proxy authentication server 20. To determine whether the fingerprint information of the CE has been registered in the proxy authentication server 20, the controller 35 may address to the proxy authentication server 20 an inquiry about whether the fingerprint information corresponding to the ID for the CE has been registered. Alternatively, information indicating whether the fingerprint information corresponding to the ID for the CE has been registered may be stored in the data repository 37, and the controller 35 may determine whether the fingerprint information of the CE has been registered in the proxy authentication server 20 by referring to the information.

If it is determined in step S108 that the fingerprint information of the CE has been registered, the controller 35 causes the fingerprint-information reading unit 31 to acquire the fingerprint information of the CE in step S104. Since an authentication process thereafter performed based on the fingerprint information of the CE that has been acquired is similar to the process for other users, description will be omitted.

If it is determined in step S108 that the fingerprint information of the CE has not been registered, the controller 35 performs a process for new registration of the fingerprint information of the CE in step S109. The process in step S109 will be described in detail below.

Then, in step S110, the controller 35 determines whether the process for new registration of the fingerprint information of the CE has succeeded.

If it is determined in step S110 that the process for new registration of the fingerprint information of the CE has succeeded, the controller 35 returns to the process in step S108 and continues an authentication process based on the registered fingerprint information. If it is determined in step S110 that the process for new registration of the fingerprint information of the CE has failed, the controller 35 returns to the process in step S101.

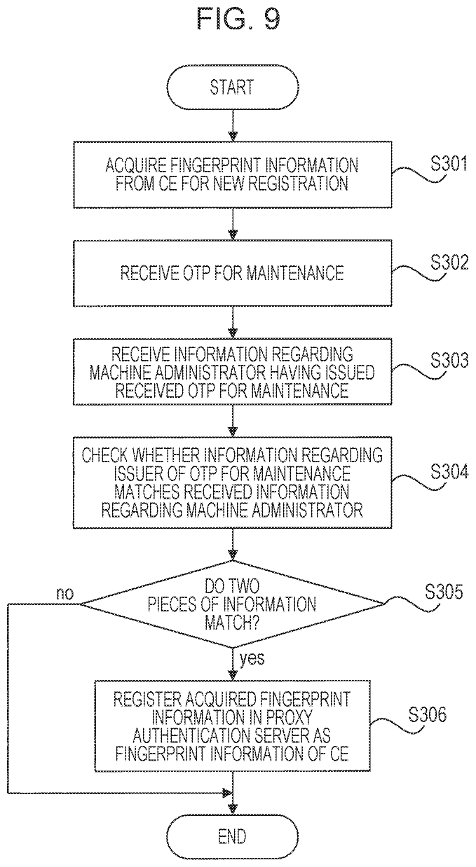

Next, referring to the flowchart in FIG. 9, detailed description will be given with regard to the process for new registration of the fingerprint information of the CE (step S109) described in the flowchart in FIG. 8.

The controller 35 first prompts the CE to place a finger on the fingerprint reader 40 in step S301 to acquire fingerprint information from the CE for new registration.

Then, the controller 35 prompts the CE to enter the OTP for maintenance in step S302 to receive the input of the OTP for maintenance from the CE.

Subsequently, in step S303, the controller 35 receives the input of the information regarding the machine administrator having issued the OTP for maintenance that has been received, examples of such information including the name and the ID of the machine administrator.

Next, in step S304, the controller 35 checks whether the stored information regarding the machine administrator having issued the OTP for maintenance matches the received information regarding the machine administrator. Then, in step S305, the controller 35 determines whether the stored information regarding the machine administrator having issued the OTP for maintenance matches the received information regarding the machine administrator.

If it is determined in step S305 that the stored information regarding the machine administrator having issued the OTP for maintenance matches the received information regarding the machine administrator, in step S306, the controller 35 registers the acquired fingerprint information in the proxy authentication server 20 as the fingerprint information of the CE.

If it is determined in step S305 that the stored information regarding the machine administrator having issued the OTP for maintenance does not match the received information regarding the machine administrator, the controller 35 completes the process.

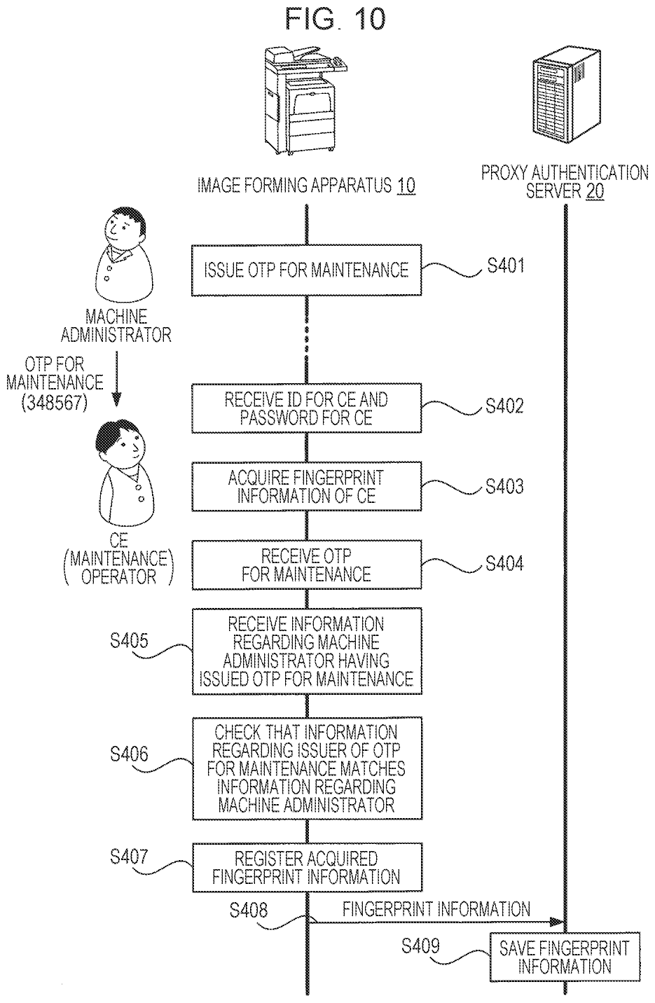

The sequence chart in FIG. 10 depicts data transmission and reception performed between the image forming apparatus 10 and the proxy authentication server 20 when a process is performed to register the fingerprint information of the CE described above.

The image forming apparatus 10 first issues an OTP for maintenance in response to operation by the machine administrator in step S401. For example, description will be given herein on the assumption that the OTP for maintenance is a string “348567”. The image forming apparatus 10 stores information regarding the issued OTP for maintenance along with information regarding, for example, the ID number and the name of the machine administrator who has instructed the issuance. The CE who is to make a visit is informed of the OTP for maintenance by the machine administrator in advance.

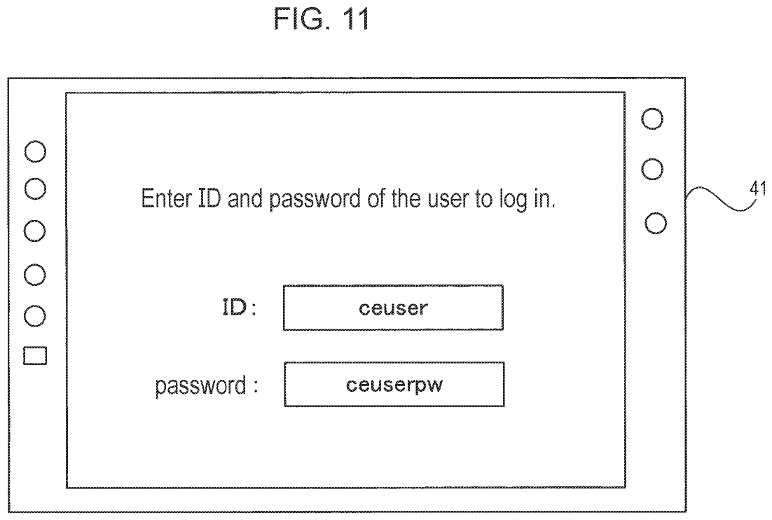

The CE informed of the OTP for maintenance visits the client company in step S402 to enter into the image forming apparatus 10 the ID for the CE and the password for the CE that are assigned in advance. FIG. 11 depicts an example of an operation screen displayed by an operation panel 41 of the image forming apparatus 10 at this time.

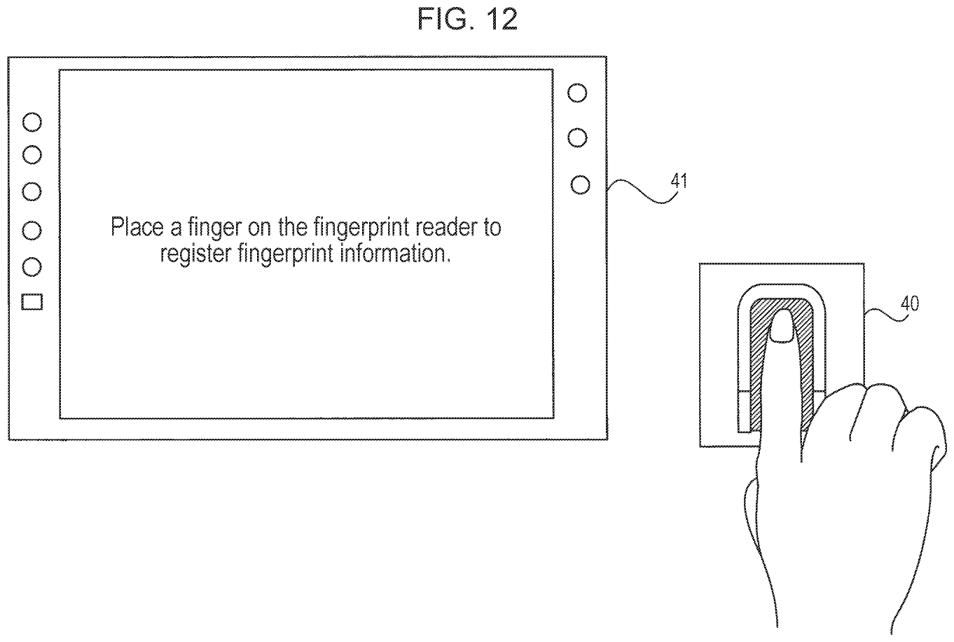

After confirming that the ID for the CE and the password for the CE that are received match the information assigned in advance, the image forming apparatus 10 checks whether the fingerprint information of the CE has been registered in the proxy authentication server 20. Since the fingerprint information of the CE has not yet been registered in the proxy authentication server 20 at this time, the image forming apparatus 10 acquires the fingerprint information of the CE in step S403. FIG. 12 depicts an example of an operation screen displayed by the operation panel 41 of the image forming apparatus 10 when the fingerprint information of the CE is acquired in this way.

Referring to FIG. 12, the operation panel 41 displays characters “Place a finger on the fingerprint reader to register fingerprint information.”, and an image is presented in which the CE places the index finger of the right hand on the fingerprint reader 40.

In step S404, the image forming apparatus 10 requests the CE to enter the OTP for maintenance. In step S405, the image forming apparatus 10 further requests the CE to enter information regarding the machine administrator having issued the OTP for maintenance.

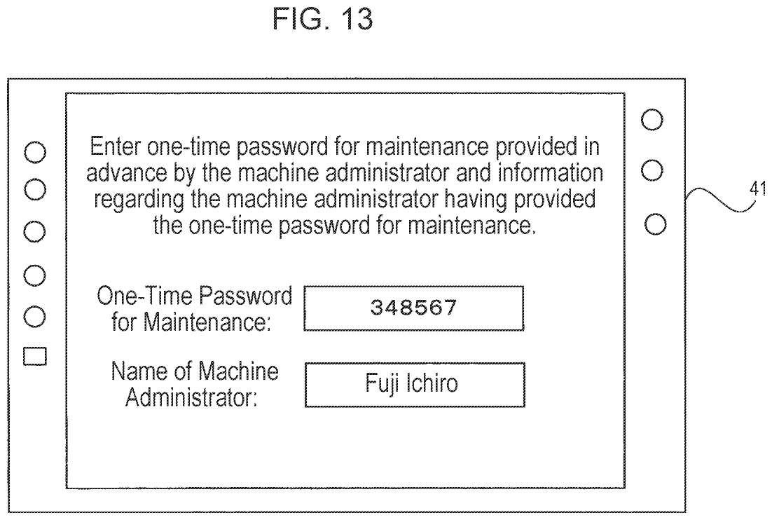

FIG. 13 depicts an example of an operation screen requesting the CE in this way to enter the OTP for maintenance and the information regarding the machine administrator having issued the OTP for maintenance.

In FIG. 13, an example of an operation screen is depicted in which the OTP for maintenance and the information regarding the machine administrator having issued the OTP for maintenance are entered simultaneously in a single screen. The example of an operation screen depicted in FIG. 13 presents an image in which the CE enters a string “348567” as the OTP for maintenance and the name of the machine administrator having issued the OTP for maintenance. The machine administrator having issued the OTP for maintenance specifically means the machine administrator having informed the CE of the OTP for maintenance.

Although the machine administrator having issued the OTP for maintenance is identified by the name of the machine administrator being entered in the case depicted in FIG. 13, the ID information of the machine administrator may be entered, or the name of the machine administrator may be selected from information representing multiple names.

Thereafter, in step S406, the image forming apparatus 10 checks that the received information regarding the machine administrator matches the information regarding the machine administrator stored in association with the OTP for maintenance.

After confirming matching in step S406, the image forming apparatus 10 performs a process of registering the acquired fingerprint information of the CE in the proxy authentication server 20 in step S407. Specifically, the image forming apparatus 10 sends the fingerprint information to the proxy authentication server 20 in step S408, and the proxy authentication server 20 saves the received fingerprint information in step S409.

While the registered fingerprint information is effective, the CE may log in to the image forming apparatus 10 in the CE mode without the need of the machine administrator being present and perform maintenance operation, thereby increasing operation efficiency. Since the CE's identity is verified by using biological information such as the fingerprint information, the occurrence of a situation in which another person changes places with the CE to log in during the maintenance operation may be avoided.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

A “system” in the present exemplary embodiment may be formed of multiple apparatuses as well as a single apparatus.

### Modifications

In the above exemplary embodiment, the case where the authentication target apparatus is an image forming apparatus has been described, but the present disclosure is not limited to the above exemplary embodiment. The present disclosure may also similarly be applied in cases where authentication target apparatuses are various information processing apparatuses each configured to authenticate a user who is to use the apparatus.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
a processor configured to:
   issue provisional authentication information in response to a request from a first user who is an administrator managing an authentication target apparatus, the provisional authentication information being assigned a validity period;
   when a second user who is to perform maintenance operation for the authentication target apparatus logs in using first authentication information that is memory information or possession information assigned in advance to the second user, request the second user to enter provisional authentication information if second authentication information is not registered, the second authentication information being biological information associated with the second user who has logged in; and
   register the biological information of the second user as the second authentication information if the provisional authentication information entered by the second user matches the provisional authentication information issued in advance.
      (((2)))

The information processing system according to (((1))),
wherein the processor is configured to, when the second user logs in using the first authentication information that is the memory information or the possession information assigned in advance to the second user and the second authentication information is registered, the second authentication information being associated with the second user who has logged in, cause the second user to undergo an authentication process based on the second authentication information and allow the second user to use the authentication target apparatus if authentication succeeds.
   (((3)))

The information processing system according to (((2))),
wherein the processor is configured to, when allowing the second user to use the authentication target apparatus, accord the second user a privilege to perform a process or processes that the first user is not accorded a privilege to perform.
   (((4)))

The information processing system according to (((1))), further comprising:
a memory,
wherein the processor is configured to
   cause the memory to store the provisional authentication information that has been issued and information regarding the first user in association with each other, the first user having requested issuance of the provisional authentication information, and
   when receiving the provisional authentication information from the second user, prompt the second user to enter information regarding the first user having issued the provisional authentication information, and register the biological information of the second user as the second authentication information only if the information regarding the first user that has been entered matches the information regarding the first user that is stored in the memory.
      (((5)))

The information processing system according to (((4))),
wherein the processor is configured to, when receiving the provisional authentication information from the second user, cause information regarding a plurality of users including the first user to be displayed, and prompt the second user to enter the information regarding the first user by selecting one user from the plurality of users that are displayed, the first user having issued the provisional authentication information.
   (((6)))

The information processing system according to any one of (((1))) to (((5))),
wherein the processor is configured to, when registering the biological information of the second user as the second authentication information, assign a validity period to the second authentication information to be registered, and invalidate the second authentication information when the validity period expires.
   (((7)))

A program causing a computer to execute a process, the process comprising:
issuing provisional authentication information in response to a request from a first user who is an administrator managing an authentication target apparatus, the provisional authentication information being assigned a validity period;
when a second user who is to perform maintenance operation for the authentication target apparatus logs in using first authentication information that is memory information or possession information assigned in advance to the second user, requesting the second user to enter provisional authentication information if second authentication information is not registered, the second authentication information being biological information associated with the second user who has logged in; and
registering the biological information of the second user as the second authentication information if the provisional authentication information entered by the second user matches the provisional authentication information issued in advance.

What is claimed is:

1. An information processing system comprising:
a processor configured to:
issue provisional authentication information in response to a request from a first user who is an administrator managing an authentication target apparatus, the provisional authentication information being assigned a validity period;
when a second user who is to perform maintenance operation for the authentication target apparatus logs in using first authentication information that is memory information or possession information assigned in advance to the second user, request the second user to enter provisional authentication information if second authentication information is not registered, the second authentication information being biological information associated with the second user who has logged in; and
register the biological information of the second user as the second authentication information if the provisional authentication information entered by the second user matches the provisional authentication information issued in advance.

2. The information processing system according to claim 1,
wherein the processor is configured to, when the second user logs in using the first authentication information that is the memory information or the possession information assigned in advance to the second user and the second authentication information is registered, the second authentication information being associated with the second user who has logged in, cause the second user to undergo an authentication process based on the second authentication information and allow the second user to use the authentication target apparatus if authentication succeeds.

3. The information processing system according to claim 2,
wherein the processor is configured to, when allowing the second user to use the authentication target apparatus, accord the second user a privilege to perform a process or processes that the first user is not accorded a privilege to perform.

4. The information processing system according to claim 1, further comprising:
a memory,
wherein the processor is configured to:
cause the memory to store the provisional authentication information that has been issued and information regarding the first user in association with each other, the first user having requested issuance of the provisional authentication information; and
when receiving the provisional authentication information from the second user, prompt the second user to enter information regarding the first user having issued the provisional authentication information, and register the biological information of the second user as the second authentication information only if the information regarding the first user that has been entered matches the information regarding the first user that is stored in the memory.

5. The information processing system according to claim 4,
wherein the processor is configured to, when receiving the provisional authentication information from the second user, cause information regarding a plurality of users including the first user to be displayed, and prompt the second user to enter the information regarding the first user by selecting one user from the plurality of users that are displayed, the first user having issued the provisional authentication information.

6. The information processing system according to claim 1,
wherein the processor is configured to, when registering the biological information of the second user as the second authentication information, assign a validity period to the second authentication information to be registered, and invalidate the second authentication information when the validity period expires.

7. A non-transitory computer readable medium storing a program causing a computer to execute a process, the process comprising:
issuing provisional authentication information in response to a request from a first user who is an administrator managing an authentication target apparatus, the provisional authentication information being assigned a validity period;
when a second user who is to perform maintenance operation for the authentication target apparatus logs in using first authentication information that is memory information or possession information assigned in advance to the second user, requesting the second user to enter provisional authentication information if second authentication information is not registered, the second authentication information being biological information associated with the second user who has logged in; and
registering the biological information of the second user as the second authentication information if the provisional authentication information entered by the second user matches the provisional authentication information issued in advance.

8. An information processing method comprising:
issuing provisional authentication information in response to a request from a first user who is an administrator managing an authentication target apparatus, the provisional authentication information being assigned a validity period;
when a second user who is to perform maintenance operation for the authentication target apparatus logs in using first authentication information that is memory information or possession information assigned in advance to the second user, requesting the second user to enter provisional authentication information if second authentication information is not registered, the second authentication information being biological information associated with the second user who has logged in; and
registering the biological information of the second user as the second authentication information if the provisional authentication information entered by the second user matches the provisional authentication information issued in advance.
